(19) United States
(12) Patent Application Publication
(10) Pub. No.: US 2021/0158247 A1
(43) Pub. Date: May 27, 2021

(54) DYNAMIC SELECTABLE AUXILIARY RESOURCE PLATFORM

(71) Applicant: Bank of America Corporation, Charlotte, NC (US)

(72) Inventor: Victoria L. Dravneek, Charlotte, NC (US)

(73) Assignee: Bank of America Corporation, Charlotte, NC (US)

(21) Appl. No.: 16/697,665

(22) Filed: Nov. 27, 2019

(51) Int. Cl. G06Q 10/06; G06N 20/00; H04L 29/08; H04L 12/911; G06F 3/14

(52) U.S. Cl. CPC G06Q 10/06312; G06N 20/00; G06F 3/14; H04L 47/783; H04L 67/20; H04L 67/10

(57) ABSTRACT

Embodiments of the invention are directed to a system, method, or computer program product for a dynamically selectable auxiliary resource platform for entity access for building and deploying auxiliary resource programs to the users of that entity. The invention generates and deploys an entity tailored auxiliary resource programs for the entity to deploy to users. The auxiliary resource platform is maintained separate from the entity, integrated within entity networks, and includes an over-time dynamic learning program to provide modifications to the deployed auxiliary resource program. Furthermore, the platform provides visible dashboard analytics to the entity based on the dynamic selectable auxiliary resource program utilized by the entity.

### BACKGROUND

In entity landscapes, users are regularly provided with auxiliary resource programs from entities. Each entity typically is required to generate the program, perform functions associated with the program, and maintain the programs. Therefore, entities may disrupt user interactions on an auxiliary resource program or not provide a program at all. As such, there exists a need for an auxiliary resource platform.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides a dynamically selectable auxiliary resource platform for entity access for subsequent deployment of an auxiliary resource platform to the users of that entity. The invention, via the platform, may setup and run entity tailored auxiliary resource programs for the entity to deploy to customers. The entity may track enrollment, resource distributions, and the like. The auxiliary resource platform is maintained separate from the entity and includes an over-time dynamic learning program to provide modifications to the auxiliary resource program, integration of other entity programs, and the like for the pooling and distribution of auxiliary resources.

Furthermore, with the platform accessing entity data and product level data, the platform provides a visible dashboard analytics to the entity based on the dynamic selectable auxiliary resource program utilized by the entity. This dashboard provides user analytics, entity metrics, inventory suggestions, and marketing strategies for modification of the auxiliary resource program and modifications to the entity model.

Furthermore, the platform, if utilized by an entity provides the entity with entity specific auxiliary resources for utilization with the financial institution associated with the platform.

In some embodiments, the invention provides for dynamic selectable auxiliary resource program deployment within entity networks, the invention comprising: authorizing access by an entity to auxiliary resource options; allowing entity selection of auxiliary resource options for generation of an entity auxiliary resource program; generating the entity auxiliary resource program based on the selected auxiliary resource options, wherein the entity auxiliary resource program comprises a data packet, wherein the data packet is converted into neutral readable program compliant with entity resource acceptance devices; integrating the auxiliary resource program into entity systems and the entity resource acceptance devices; communicable linking to the entity resource acceptance devices to identify user interactions with the entity via the entity resource acceptance devices; plotting resource distributions by the user at the entity resource acceptance device; and displaying an independent dashboard to the user and the entity, wherein the user is displayed a user dashboard illustrating user auxiliary resource accrual and the entity is displayed an entity dashboard illustrating user utilization of auxiliary resources.

In some embodiments, the invention further comprises performing continual over-time dynamic learning of auxiliary resource programs across entities for modification of the auxiliary resource options presented to entities for selection for the entity auxiliary resource program.

In some embodiments, plotting the resource distributions by the user at the entity resource acceptance device further comprises identify an overall resource distribution, a per item resource distribution, and an item level identification of each product or service of a transaction associated with the resource distribution.

In some embodiments, the invention further comprises generating the auxiliary resource options by extraction of current and historic auxiliary resource program portions from third party auxiliary resource programs.

In some embodiments, the user dashboard further provides a coordination of all user enrollment in auxiliary resource programs across multiple entities and displays the user progression for the multiple entities auxiliary resource programs. In some embodiments, the user dashboard further allows for user combination of auxiliary resources across multiple entities.

In some embodiments, the auxiliary resource programs further comprise loyalty programs for user affiliation with the entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a dynamic selectable auxiliary resource platform system environment, in accordance with one embodiment of the present invention;

FIG. 2 provides a high level process flow illustrating auxiliary resource program deployment from the auxiliary resource platform, in accordance with one embodiment of the present invention;

FIG. 3 provides a process flow illustrating generating selectable program options on the auxiliary resource platform, in accordance with one embodiment of the present invention; and

FIG. 4 provides a process flow illustrating utilization of the auxiliary resource platform by an entity and a user, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any customer of an entity or individual that interacts with an entity. The user may interact with the entity as a customer, such as a customer purchasing a product or service. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

As used herein, the term “resource” may refer to physical currency, electronic data, or an exchangeable currency having a value (e.g., funds) or the like. A computing resource may refer to elements of one or more computing devices (e.g., processor, memory, communication device, and the like) networks, or the like available to be used in the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison). As used herein, a “resource vehicle” may refer to any medium for resource conveyance from one resource location to another. For example, a resource vehicle may comprise a credit or debit card, a check, a wire transfer, a gift card, or the like. In one embodiment, a resource vehicle may comprise a data transfer mechanism or device (e.g., a thumb drive or other removable data storage). An “auxiliary resource” may be any rewards, loyalty points, coupons, benefits, or the like that are received by a user as a result and auxiliary to a main resource distribution between the user and an entity. An “auxiliary resource program” may be any loyalty, reward, or benefit program provided by an entity or financial institution to a user or entity.

As used herein, an “interaction” or “connection” may refer to any communication between one or more users and a merchant or systems within the system environment described herein. For example, an interaction may refer to a transfer or exchange of resources (e.g., data, information, funds, and the like) between systems, devices, and/or application; an accessing of stored data by one or more devices; a transmission of a requested task; a sharing or leveraging of resources (e.g., computing resources) between device; or the like. An interaction may include user interactions with a user interface (e.g., clicking, swiping, text or data entry, and the like), authentication actions (e.g., signing-in, username and password entry, PIN entry, and the like), account actions (e.g., account access, fund transfers, and the like) and the like. In a specific embodiment, an “interaction” may refer to a resource transfer executed between one or more users and/or entities (e.g., a transaction).

As used herein, the term “entity” may be used to include any merchant that the user may interact with to complete a transaction for a product or service. The terms “financial institution” and “financial entity” may be used to include any organization that processes financial transactions including, but not limited to, banks, credit unions, savings and loan associations, investment companies, stock brokerages, insurance companies, and the like. In other embodiments, an entity may be a business, organization, a government organization or the like that is not a financial institution. In a specific embodiment, an entity is a resource providing entity such as a financial institution that provides a resource vehicle and/or location (e.g., a credit card and associated account) to a user. The resource vehicle and/or location may include supplementary resources.

As used herein, “authentication information” may refer to any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to at least partially authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system.

A “resource distribution” refers to any transaction or communication between a user and either an entity or the financial institution to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

The invention provides a dynamically selectable auxiliary resource platform for entity access for subsequent deployment of an auxiliary resource platform to the users of that entity. The invention, via the platform, may setup and run entity tailored auxiliary resource programs for the entity to deploy to customers. The entity may track enrollment, resource distributions, and the like. The auxiliary resource platform is maintained separate from the entity and includes an over-time dynamic learning program to provide modifications to the auxiliary resource program, integration of other entity programs, and the like for the pooling and distribution of auxiliary resources.

Furthermore, with the platform accessing entity data and product level data, the platform provides a visible dashboard analytics to the entity based on the dynamic selectable auxiliary resource program utilized by the entity. This dashboard provides user analytics, entity metrics, inventory suggestions, and marketing strategies for modification of the auxiliary resource program and modifications to the entity model.

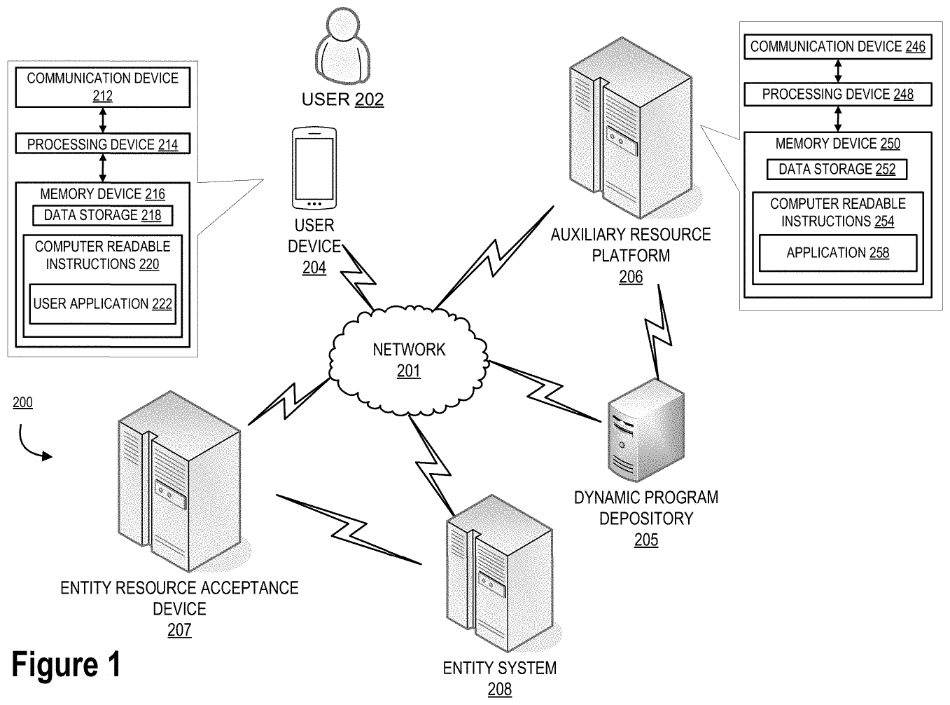

FIG. 1 provides a dynamic selectable auxiliary resource platform system environment 200, in accordance with one embodiment of the present invention. FIG. 1 provides the system environment 200 for which the distributive network system with specialized data feeds associated with an interconnected resource distribution and retention network. FIG. 1 provides a unique system that includes specialized servers and system communicably linked across a distributive network of nodes required to perform the functions described herein.

As illustrated in FIG. 1, the entity system 208 is operatively coupled, via a network 201 to the user device 204, dynamic program depository 205, entity resource acceptance device 207, and to the auxiliary resource platform 206. In this way, the entity system 208 can send information to and receive information from the user device 204, entity resource acceptance device 207, and the auxiliary resource platform 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or entity that has one or more user devices 204. The user 202 may be a customer of an entity. The user 202 may wish to complete a transaction with the entity. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the auxiliary resource platform 206, the entity system 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the auxiliary resource platform 206.

As further illustrated in FIG. 1, the auxiliary resource platform 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the entity system 208, the entity resource acceptance device 207, the dynamic program depository 205, and the user device 204. As such, the communication device 246 generally comprises a modem, server, or other device for communicating with other devices on the network 201.

As further illustrated in FIG. 1, the auxiliary resource platform 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the auxiliary resource platform 206 the memory device 250 stores an application 258. In one embodiment of the invention, the application 258 may associate with applications having computer-executable program code. Furthermore, the auxiliary resource platform 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more entity system 208, entity resource acceptance device 207, dynamic program depository 205, and/or user device 204.

As illustrated in FIG. 1, the entity resource acceptance device 207 is connected to the entity system 208, user device 204, dynamic program depository 205, and auxiliary resource platform 206. The entity resource acceptance device 207 has the same or similar components as described above with respect to the user device 204 and the auxiliary resource platform 206. While only one entity resource acceptance device 207 is illustrated in FIG. 1, it is understood that multiple entity resource acceptance device 207 may make up the system environment 200. The entity resource acceptance device 207 may be associated with one or more financial institutions, entities, or the like and function as a point-of-sale device or point-of-transaction device for the user to interact with in order to complete a transaction with the merchant.

In various embodiments, the entity resource acceptance device 207 may be a resource acceptance device that may be or include a merchant machine and/or server and/or may be or include the mobile device of the user may function as a point of transaction device. The embodiments described herein may refer to the use of a transaction, transaction event or point of transaction event to trigger the steps, functions, routines and the like described herein. In various embodiments, occurrence of a transaction triggers the sending of information such as alerts and the like. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments; sending remittances; transferring balances from one account to another account; loading money onto stored value cards (SVCs) and/or prepaid cards; donating to charities; and/or the like.

In some embodiments, the transaction or resource distribution may refer to an event and/or action or group of actions facilitated or performed by a user's device, such as a user's mobile device. Such a device may be referred to herein as a “resource acceptance device”. A “point-of-transaction” could refer to any location, virtual location or otherwise proximate occurrence of a transaction or resource distribution. A “resource acceptance device” may refer to any device used to perform a transaction, either from the user's perspective, the merchant's perspective or both. In some embodiments, the resource acceptance device refers only to a user's device, in other embodiments it refers only to a merchant device, and in yet other embodiments, it refers to both a user device and a merchant device interacting to perform a transaction. For example, in one embodiment, the resource acceptance device refers to the user's mobile device configured to communicate with a merchant's point of sale terminal, whereas in other embodiments, the resource acceptance device refers to the merchant's point of sale terminal configured to communicate with a user's mobile device, and in yet other embodiments, the resource acceptance device refers to both the user's mobile device and the merchant's point of sale terminal configured to communicate with each other to carry out a transaction.

In some embodiments, the entity resource acceptance device 207 is or includes an interactive computer terminal that is configured to initiate, perform, complete, and/or facilitate one or more transactions. The entity resource acceptance device 207 could be or include any device that a user may use to perform a transaction with an entity, such as, but not limited to, an ATM, a loyalty device such as a rewards card, loyalty card or other loyalty device, a magnetic-based payment device (e.g., a credit card, debit card, and the like), a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, cellular phone, personal digital assistant (PDA) device, MP3 device, personal GPS device, and the like), a merchant terminal, a self-service machine (e.g., vending machine, self-checkout machine, and the like), a public and/or business kiosk (e.g., an Internet kiosk, ticketing kiosk, bill pay kiosk, and the like), a gaming device, and/or various combinations of the foregoing.

In some embodiments, the entity resource acceptance device 207 is operated in a public place (e.g., on a street corner, at the doorstep of a private residence, in an open market, at a public rest stop, and the like). In other embodiments, the entity resource acceptance device 207 is additionally or alternatively operated in a place of business (e.g., in a retail store, post office, banking center, grocery store, factory floor, and the like). In accordance with some embodiments, the entity resource acceptance device 207 is not owned by the user of the resource acceptance device. Rather, in some embodiments, the entity resource acceptance device 207 is owned by a mobile business operator or a point-of-transaction operator (e.g., merchant, vendor, salesperson, and the like). In yet other embodiments, the entity resource acceptance device 207 is owned by the financial institution offering the resource acceptance device providing functionality in accordance with embodiments of the invention described herein.

As illustrated in FIG. 1, the dynamic program depository 205 is connected to the auxiliary resource platform 206. The dynamic program depository 205 has the same or similar components as described above with respect to the user device 204 and the auxiliary resource platform 206. While only one dynamic program depository 205 is illustrated in FIG. 1, it is understood that multiple dynamic program depository 205 may make up the system environment 200.

The dynamic program depository 205 stores program options, loyalty information associated with users, accounts associated with the users, accounts associated with the entity, and the like. In this way, the dynamic program depository 205 may store step by step instructions for applying programs and dynamically modifying programs for the auxiliary resource platform 206.

The dynamic program depository 205 may be connected to the auxiliary resource platform 206 via the network 201 for the auxiliary resource platform 206 to perform a search of the dynamic program depository 205 for identification of a specific program options, user auxiliary accumulation, and the like. Furthermore, the dynamic program depository 205 may communicate with the same network protocol and compatibility with the user device 204 for deployment of the codes to the user 202.

As illustrated in FIG. 1, the entity system 208 is connected to the entity resource acceptance device 207, user device 204, dynamic program depository 205, and auxiliary resource platform 206. The entity system 208 may be associated with a merchant and the entity resource acceptance device 207. The entity system 208 has the same or similar components as described above with respect to the user device 204 and the auxiliary resource platform 206. While only one entity system 208 is illustrated in FIG. 1, it is understood that multiple entity system 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The entity system 208 may generally include a processing device communicably coupled to devices as a memory device, output devices, input devices, a network interface, a power source, one or more chips, and the like. The entity system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the entity system 208 described herein.

Embodiments of the invention are directed to a system, method, or computer program product for a dynamically selectable auxiliary resource platform for entity access for building and deploying auxiliary resource programs to the users of that entity. The invention generates and deploys an entity tailored auxiliary resource programs for the entity to deploy to users. The auxiliary resource platform is maintained separate from the entity, integrated within entity networks, and includes an over-time dynamic learning program to provide modifications to the deployed auxiliary resource program. Furthermore, the platform provides visible dashboard analytics to the entity based on the dynamic selectable auxiliary resource program utilized by the entity.

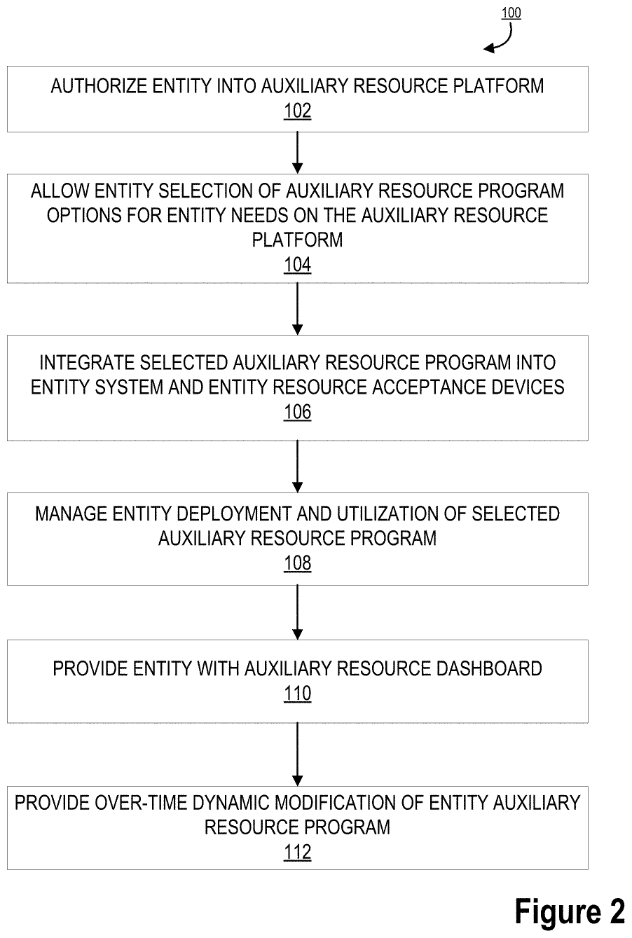

FIG. 2 provides a high level process flow illustrating auxiliary resource program deployment from the auxiliary resource platform 100, in accordance with one embodiment of the present invention. As illustrated in block 102, the process 100 is initiated by authorizing an entity into the auxiliary resource platform. In this way, the system may enroll an entity to gain access to the platform and depository in order for the entity to build an auxiliary resource program for the entity's customers. The entity may sign up for the auxiliary resource platform and be able to opt-in or opt-out at any time. Furthermore the financial institution associated with the auxiliary resource platform may confirm authenticity of entity and confirm the entity is in good standing to gain access to the data sharing on the platform.

Once authorized, the entity may gain access to the auxiliary resource platform and the data regarding auxiliary resource programs within the depository. As such, as illustrated in block 104, the process 100 continues by allowing the entity to select auxiliary resource program options for the entity needs on the auxiliary resource platform. The options may comprise of a type of program, such as points, coupons, rewards, or the like. The options may also include a conversion rate for how auxiliary resources are accumulated by the user and the rate in which those auxiliary resources are accumulated. Furthermore, the options may allow for increased auxiliary resource distribution based on a specific product or service purchases, the frequency of the user interactions, the amount of the user interactions, and the like. As such, the platform provides options for initiation of the program, the type of program, the conversion rate for the program, and alternative auxiliary resource options for frequent users.

In some embodiments, the options for initiation of the program further comprise providing a type of program. This may be different for different entity sectors and could include a mileage program, a rewards program, points, resource retrieval, variable access, benefits, coupon programs, or the like. As such, based on the entity sector the platform may provide an adaptive type of program for the entity.

In some embodiments, the conversion rate for the program further comprises providing an algorithmic scale for the calculation of conversions for auxiliary resource accumulation. In this way, for example the platform may provide a point for a specific amount of resources spent. The conversion rate may be set by the entity and may progress or change based on user frequency of the entity, amount of resources distributed by the user to the resource, duration of time the user is a customer of the entity, or the like.

In some embodiments, the alternative auxiliary resource options for specific users. In this way, the platform may allow for specific tailoring of auxiliary resource distribution to users based on specific users. For example, the platform may provide new users, frequent users, high volume users, or the like with more auxiliary resources. Alternatively, the platform may provide passive users with more auxiliary resources based on timing to incentives passive users to transact with the entity.

Once the entity has selected the program options, the platform may bundle the options for the entity. This may require conversion of software components to a neutral readable program compliant with entity specific firewall and network requirements. Once the bundle has been established and tested for compliance with entity networks, as illustrated in block 106, the process 100 continues by integrating the selected auxiliary resource program into the entity system and entity resource acceptance devices associated with the entity. As such, the platform is integrated within entity systems for presentment of the auxiliary resource program to the entity and to users via the entity systems.

As illustrated in block 108, once the program is presented to the entity, the platform may continue to manage entity deployment and utilization of the selected auxiliary resource program. As such, the platform may monitor and extract usage information about the program and maintain the information for the entity.

As illustrated in block 110, the process 100 continues by providing the entity with an entity auxiliary resource dashboard. The dashboard may display information about users, auxiliary resources, inventory data based on user transactions, proposed modifications to the auxiliary resource program, and the like. As illustrated in block 112, using the data from the entity live auxiliary resource program and historic data from other entity auxiliary resource programs, the platform may provide over-time dynamic modifications to the entity auxiliary resource program. These modifications may be auxiliary resource modifications or the like.

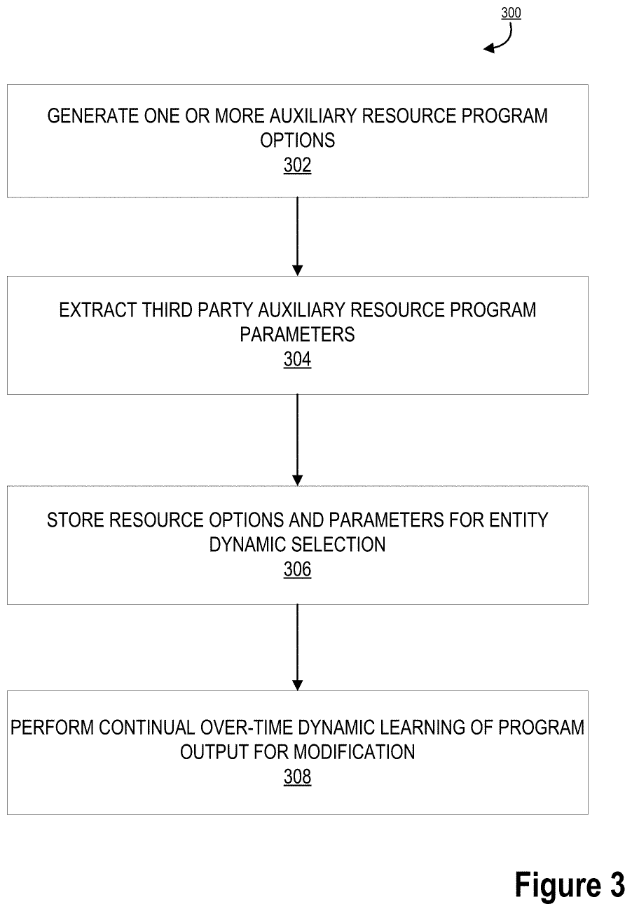

FIG. 3 provides a process flow illustrating generating selectable program options on the auxiliary resource platform 300, in accordance with one embodiment of the present invention. As illustrated in block 302, the process 300 is initiated by generating one or more auxiliary program options for entity selectivity on the platform.

The options may comprise of a type of program, such as points, coupons, rewards, or the like. The options may also include a conversion rate for how auxiliary resources are accumulated by the user and the rate in which those auxiliary resources are accumulated. Furthermore, the options may allow for increased auxiliary resource distribution based on a specific product or service purchases, the frequency of the user interactions, the amount of the user interactions, and the like. As such, the platform provides options for initiation of the program, the type of program, the conversion rate for the program, and alternative auxiliary resource options for frequent users.

In some embodiments, the options for initiation of the program further comprise providing a type of program. This may be different for different entity sectors and could include a mileage program, a rewards program, points, resource retrieval, variable access, benefits, coupon programs, or the like. As such, based on the entity sector the platform may provide an adaptive type of program for the entity.

In some embodiments, the conversion rate for the program further comprises providing an algorithmic scale for the calculation of conversions for auxiliary resource accumulation. In this way, for example the platform may provide a point for a specific amount of resources spent. The conversion rate may be set by the entity and may progress or change based on user frequency of the entity, amount of resources distributed by the user to the resource, duration of time the user is a customer of the entity, or the like.

In some embodiments, the alternative auxiliary resource options for specific users. In this way, the platform may allow for specific tailoring of auxiliary resource distribution to users based on specific users. For example, the platform may provide new users, frequent users, high volume users, or the like with more auxiliary resources. Alternatively, the platform may provide passive users with more auxiliary resources based on timing to incentives passive users to transact with the entity.

Next, as illustrated in block 304, the process 300 may continue by extracting third party auxiliary resource program parameters. In this way, the platform may review other entities and the structure of their programs. The structure and format of the other entity programs may be reviewed and digested by the platform for options for the entity to select.

As illustrated in block 306, the process 300 continues by storing the resource options and parameters for entity dynamic selection within the dynamic program depository. As such, the options and parameters are stored and searchable by the entity in order for the entity to extract the options and parameters for the entity program.

Finally, as illustrated in block 308, the process 300 continues by performing continual over-time dynamic learning of program output for modifications. In this way, the platform may continue to monitory the entity auxiliary resource program and provide modifications to the program as necessary based on auxiliary resources, growth, geographic diversity, technology improvements, or the like.

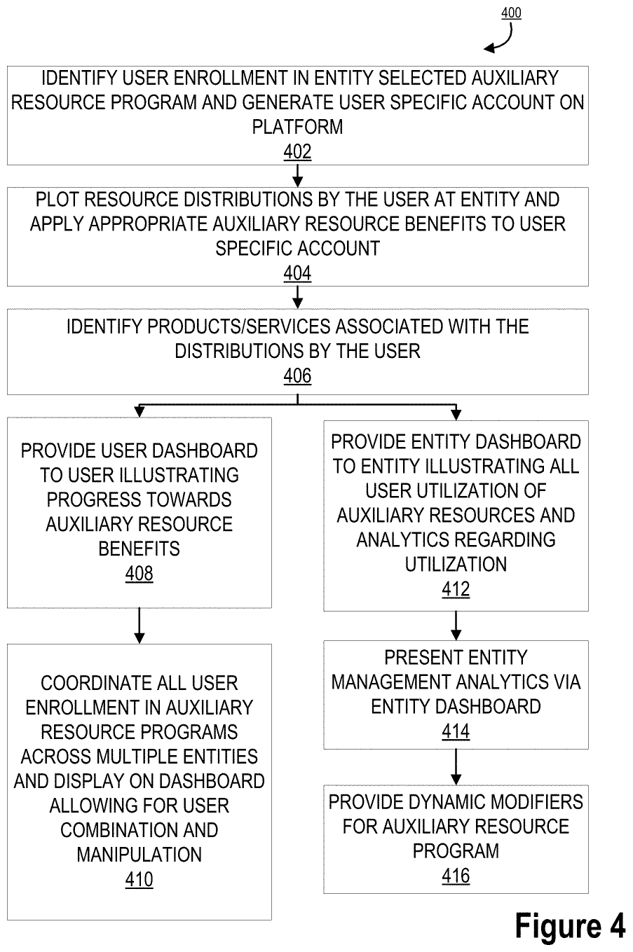

FIG. 4 provides a process flow illustrating utilization of the auxiliary resource platform by an entity and a user 400, in accordance with one embodiment of the present invention. As illustrated in block 402, the process 400 is initiated by identifying a user enrollment in the entity selected auxiliary resource program. As such, the platform may generate a user specific account for the auxiliary resource program of that entity. The user specific account may contain all of the auxiliary resources that the user accumulates through the auxiliary resource program associated with the entity and/or from other entities that have auxiliary resource programs. Once the user is enrolled, the platform may maintain the user's utilization of the auxiliary resource program within a user specific account.

As illustrated in block 404, the process 400 continues by plotting the resource distributions by the user at the entity and apply the appropriate auxiliary resource benefits to the user specific account. In this way, the platform may integrate within the entity systems and entity resource acceptance devices and monitory the resource distribution and transactions associated with those devices. As such, the platform may monitor the transactions and the products and/or services associated with the transactions and calculate the auxiliary resources associated with the transactions. The platform may then apply the auxiliary resources to the user specific account and store the auxiliary resources in the user account.

Next, as illustrated in block 406, the process 400 continues by identifying the products and/or services associated with the distribution that occurred between the user and the entity. In this way, the platform may identify the product level data associated with the user transaction with the entity. The platform may also identify a total resource amount of the interaction. The platform may convert the amount and the products purchased in to an appropriate auxiliary resource amount and store the auxiliary resources in the user specific account. Furthermore, the user may be able to use any additional auxiliary resources that the user may have and may be able to apply those previously obtained auxiliary resources. As such, the platform monitors the transaction through use of the auxiliary resource program the entity has selected and embedded within the system networks. The program monitors the products of the transaction, the resource amount, and the like. The platform then stores the information about the transaction. In addition to storing the information about the transaction, the platform may perform conversion of the transaction information into auxiliary resources and store the transaction information and converted auxiliary resources within the user specific account.

At this point in the process 400, the process splits between user and entity actions. As illustrated in block 408, the user is provided a user dashboard that illustrates progress towards auxiliary resource benefits. The dashboard may be accessed via the user device. The dashboard may provide the user with information about transactions, auxiliary resource accrual, and the like. This may be for the entity and for other entities. As such, the dashboard extracts and provides the user with a wholistic view of all the user's auxiliary resource accrual across various entities. As illustrated in block 410, the process 400 continues by coordinating all of the user enrollment in auxiliary resources programs across the multiple entities and provides a display of those on the dashboard. This allows the user not only to view all of the auxiliary resources they have, but the platform also allows the user to modify and/or combine the auxiliary resources from various different entities into one for use at a single entity.

As illustrated in block 412, the process 400 shifts to providing the entity with an entity dashboard. As illustrated, the platform may provide an entity dashboard to illustrate all users utilizing the entity auxiliary resource program and provides analytics regarding the utilization. The dashboard may provide the entity with information about each user, the auxiliary resources accrued by each user, and the like. Furthermore, the platform may provide analytics regarding user utilization. This may include location analytics, product analytics, and the like that may compare and identify peak locations and peak times for product purchasing. As such, aiding in inventory and staffing for future dates.

As illustrated in block 414, the process 400 continues by presenting the entity management auxiliary via the entity dashboard. This may include management modifications or suggestion for the auxiliary resource program based on entity changes or changes in auxiliary resource programs. Based on these possible modifications, the platform may also provide dynamic modifiers for the auxiliary resource program, as illustrated in block 416. Thus, continuing updating and creating a modern auxiliary resource program for the entity.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic selectable auxiliary resource program deployment within entity networks, the system comprising:
a memory device with computer-readable program code stored thereon;
a communication device, wherein the communication device is configured to establish operative communication with a plurality of networked devices via a communication network;
a processing device operatively coupled to the memory device and the communication device, wherein the processing device is configured to execute the computer-readable program code to:
authorize access by an entity to auxiliary resource options;
allow entity selection of auxiliary resource options for generation of an entity auxiliary resource program;
generate the entity auxiliary resource program based on the selected auxiliary resource options, wherein the entity auxiliary resource program comprises a data packet, wherein the data packet is converted into neutral readable program compliant with entity resource acceptance devices;
integrate the auxiliary resource program into entity systems and the entity resource acceptance devices;
communicable link to the entity resource acceptance devices to identify user interactions with the entity via the entity resource acceptance devices;
plot resource distributions by the user at the entity resource acceptance device; and
display an independent dashboard to the user and the entity, wherein the user is displayed a user dashboard illustrating user auxiliary resource accrual and the entity is displayed an entity dashboard illustrating user utilization of auxiliary resources.

2. The system of claim 1, further comprising performing continual over-time dynamic learning of auxiliary resource programs across entities for modification of the auxiliary resource options presented to entities for selection for the entity auxiliary resource program.

3. The system of claim 1, wherein plotting the resource distributions by the user at the entity resource acceptance device further comprises identify an overall resource distribution, a per item resource distribution, and an item level identification of each product or service of a transaction associated with the resource distribution.

4. The system of claim 1, further comprising generating the auxiliary resource options by extraction of current and historic auxiliary resource program portions from third party auxiliary resource programs.

5. The system of claim 1, wherein the user dashboard further provides a coordination of all user enrollment in auxiliary resource programs across multiple entities and displays the user progression for the multiple entities auxiliary resource programs.

6. The system of claim 1, wherein the user dashboard further allows for user combination of auxiliary resources across multiple entities.

7. The system of claim 1, wherein auxiliary resource programs further comprise loyalty programs for user affiliation with the entity.

8. A computer program product for dynamic selectable auxiliary resource program deployment within entity networks, the computer program product comprising at least one non-transitory computer-readable medium having computer-readable program code portions embodied therein, the computer-readable program code portions comprising:
an executable portion configured for extracting authorizing access by an entity to auxiliary resource options;
an executable portion configured for allowing entity selection of auxiliary resource options for generation of an entity auxiliary resource program;
an executable portion configured for generating the entity auxiliary resource program based on the selected auxiliary resource options, wherein the entity auxiliary resource program comprises a data packet, wherein the data packet is converted into neutral readable program compliant with entity resource acceptance devices;
an executable portion configured for integrating the auxiliary resource program into entity systems and the entity resource acceptance devices;
an executable portion configured for communicable linking to the entity resource acceptance devices to identify user interactions with the entity via the entity resource acceptance devices;
an executable portion configured for plotting resource distributions by the user at the entity resource acceptance device; and
an executable portion configured for displaying an independent dashboard to the user and the entity, wherein the user is displayed a user dashboard illustrating user auxiliary resource accrual and the entity is displayed an entity dashboard illustrating user utilization of auxiliary resources.

9. The computer program product of claim 8, further comprising an executable portion configured for performing continual over-time dynamic learning of auxiliary resource programs across entities for modification of the auxiliary resource options presented to entities for selection for the entity auxiliary resource program.

10. The computer program product of claim 8, wherein plotting the resource distributions by the user at the entity resource acceptance device further comprises identify an overall resource distribution, a per item resource distribution, and an item level identification of each product or service of a transaction associated with the resource distribution.

11. The computer program product of claim 8, further comprising an executable portion configured for generating the auxiliary resource options by extraction of current and historic auxiliary resource program portions from third party auxiliary resource programs.

12. The computer program product of claim 8, wherein the user dashboard further provides a coordination of all user enrollment in auxiliary resource programs across multiple entities and displays the user progression for the multiple entities auxiliary resource programs.

13. The computer program product of claim 8, wherein the user dashboard further allows for user combination of auxiliary resources across multiple entities.

14. The computer program product of claim 8, wherein auxiliary resource programs further comprise loyalty programs for user affiliation with the entity.

15. A computer-implemented method for dynamic selectable auxiliary resource program deployment within entity networks, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
authorizing access by an entity to auxiliary resource options;
allowing entity selection of auxiliary resource options for generation of an entity auxiliary resource program;
generating the entity auxiliary resource program based on the selected auxiliary resource options, wherein the entity auxiliary resource program comprises a data packet, wherein the data packet is converted into neutral readable program compliant with entity resource acceptance devices;
integrating the auxiliary resource program into entity systems and the entity resource acceptance devices;
communicable linking to the entity resource acceptance devices to identify user interactions with the entity via the entity resource acceptance devices;
plotting resource distributions by the user at the entity resource acceptance device; and
displaying an independent dashboard to the user and the entity, wherein the user is displayed a user dashboard illustrating user auxiliary resource accrual and the entity is displayed an entity dashboard illustrating user utilization of auxiliary resources.

16. The computer-implemented of claim 15, further comprising performing continual over-time dynamic learning of auxiliary resource programs across entities for modification of the auxiliary resource options presented to entities for selection for the entity auxiliary resource program.

17. The computer-implemented of claim 15, wherein plotting the resource distributions by the user at the entity resource acceptance device further comprises identify an overall resource distribution, a per item resource distribution, and an item level identification of each product or service of a transaction associated with the resource distribution.

18. The computer-implemented of claim 15, further comprising generating the auxiliary resource options by extraction of current and historic auxiliary resource program portions from third party auxiliary resource programs.

19. The computer-implemented of claim 15, wherein the user dashboard further provides a coordination of all user enrollment in auxiliary resource programs across multiple entities and displays the user progression for the multiple entities auxiliary resource programs.

20. The computer-implemented of claim 15, wherein the user dashboard further allows for user combination of auxiliary resources across multiple entities.
